(19) United States
(12) Patent Application Publication
(10) Pub. No.: US 2025/0176572 A1
(43) Pub. Date: Jun. 5, 2025

(54) SMOKE GENERATING ASSEMBLY FOR AN INDOOR SMOKER

(71) Applicant: Haier US Appliance Solutions, Inc., Wilmington, DE (US)

(72) Inventors: Daniel Carballo, Louisville, KY (US); Richard Dean Suel, II, Louisville, KY (US); George Carpenter, Louisville, KY (US)

(21) Appl. No.: 18/526,583

(22) Filed: Dec. 1, 2023

(51) Int. Cl. A23B 4/052; F23K 3/00; G05D 23/19

(52) U.S. Cl. CPC A23B 4/052; F23K 3/00; G05D 23/1951

(57) ABSTRACT

A smoke generating assembly includes a smoke barrel defining a smoldering chamber, an auger positioned within the smoke barrel and being rotatable to urge combustible material through the smoldering chamber, a smoldering heater positioned adjacent the smoke barrel for smoldering the combustible material as the auger advances the combustible material past the smoldering heater, a temperature sensor in thermal communication with the smoldering heater for measuring a smoldering temperature, and a controller configured to operate the smoldering heater to regulate the smoldering temperature to a target smoldering temperature.

### FIELD OF THE INVENTION

The present subject matter relates generally to indoor smokers, and more particularly to smoke generating assemblies for indoor smokers.

### BACKGROUND OF THE INVENTION

Conventional smokers include a smoking chamber and a firebox positioned within or fluidly coupled to the smoking chamber. The firebox is filled with a combustible material, such as wood or wood byproducts that are ignited or otherwise heated to generate smoke and/or heat. The heat and smoke are routed into the smoking chamber to impart flavor on and cook food items positioned within the smoking chamber. One or more heating elements may be positioned within the smoking chamber and the firebox to maintain the temperatures necessary both for cooking the food and for generating the desired amount of smoke.

Certain conventional meat smokers rely on pellet ignition sources or smoldering heaters that are seated against and thermally coupled to the pellet feed source. However, conventional pellet smokers do not control the smoldering temperature of the fuel during smoke generation. This can result in poor quality smoke that is difficult to control and difficult to predict. Typical pellet smokers also do not have a controlled understanding of the rate at which they can expect to produce energy and smoke from a given pellet. In other words, conventional pellet smokers dump pellets into a heated open-loop crucible and then react accordingly for impacts to temperature.

Accordingly, a smoker that has features for improved smoke generation would be useful. More specifically, a smoke generating assembly with improved temperature control and ability to manage pellet smoldering would be particularly beneficial.

### BRIEF DESCRIPTION OF THE INVENTION

Aspects and advantages of the invention will be set forth in part in the following description, may be apparent from the description, or may be learned through practice of the invention.

In one exemplary embodiment, a smoke generating assembly is provided, including a smoke barrel defining a smoldering chamber that extends between a first end and a second end along a central axis, the smoke barrel being configured for receiving combustible material, an auger positioned within the smoke barrel and being rotatable about the central axis for selectively urging the combustible material from the first end toward the second end of the smoldering chamber, a smoldering heater positioned adjacent the smoke barrel for smoldering the combustible material as the auger advances the combustible material past the smoldering heater, a temperature sensor in thermal communication with the smoldering heater for measuring a smoldering temperature, and a controller in operative communication with the smoldering heater and the temperature sensor, the controller being configured to operate the smoldering heater to regulate the smoldering temperature to a target smoldering temperature.

In another exemplary embodiment, a method of operating a smoke generating assembly is provided. The smoke generating assembly includes a smoldering heater positioned adjacent a smoke barrel for smoldering combustible material as an auger advances the combustible material past the smoldering heater and a temperature sensor in thermal communication with the smoldering heater. The method includes receiving a user input including a target smoke intensity level, determining a target smoldering temperature from the target smoke intensity level, obtaining a smoldering temperature of the smoldering heater using the temperature sensor, and operating the smoldering heater to regulate the smoldering temperature to the target smoldering temperature.

According to still another example embodiment, an indoor smoker is provided, including a cabinet, a smoking chamber positioned within the cabinet, and a smoke generating assembly for providing a flow of smoke into the smoking chamber. The smoke generating assembly includes a smoke barrel defining a smoldering chamber that extends between a first end and a second end along a central axis, the smoke barrel being configured for receiving combustible material, an auger positioned within the smoke barrel and being rotatable about the central axis for selectively urging the combustible material from the first end toward the second end of the smoldering chamber, a smoldering heater positioned adjacent the smoke barrel for smoldering the combustible material as the auger advances the combustible material past the smoldering heater, a temperature sensor in thermal communication with the smoldering heater for measuring a smoldering temperature, and a controller in operative communication with the smoldering heater and the temperature sensor, the controller being configured to operate the smoldering heater to regulate the smoldering temperature to a target smoldering temperature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an indoor smoker with a door in a closed position in accordance with an example embodiment of the present disclosure.

FIG. 2 provides a perspective view of the exemplary indoor smoker of FIG. 1 with the door opened.

FIG. 3 provides a partial perspective view of an indoor smoker according to an exemplary embodiment of the present subject matter.

FIG. 4 is a front cross sectional view of the exemplary indoor smoker of FIG. 3 according to an exemplary embodiment of the present subject matter.

FIG. 5 is a side cross sectional view of the exemplary indoor smoker of FIG. 3 according to an exemplary embodiment of the present subject matter.

FIG. 6 is a cross sectional view of a smoke generating assembly according to an exemplary embodiment of the present subject matter.

FIG. 7 illustrates a method for operating a smoke generating assembly in accordance with one embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

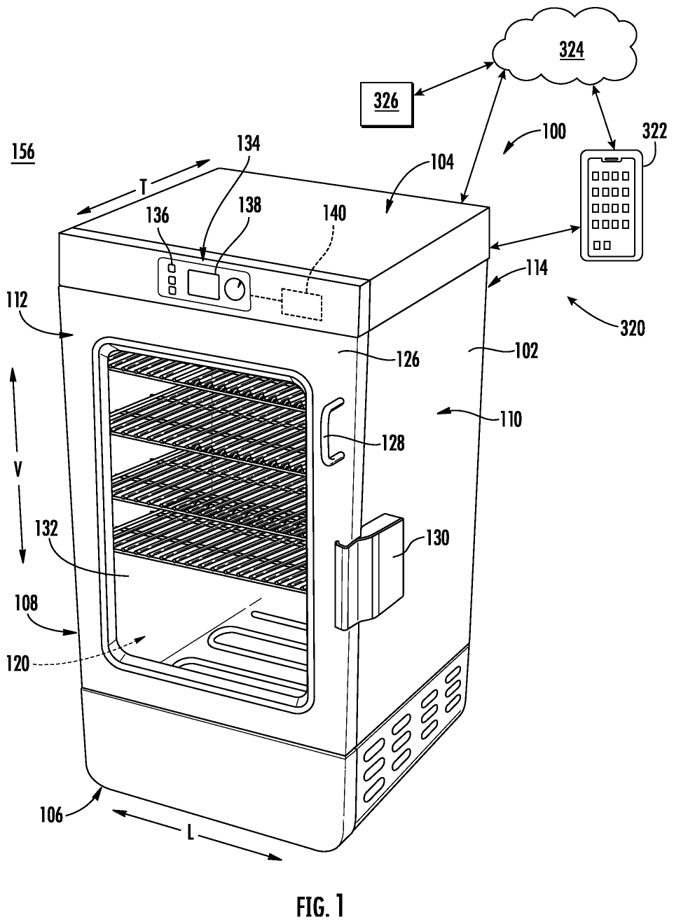

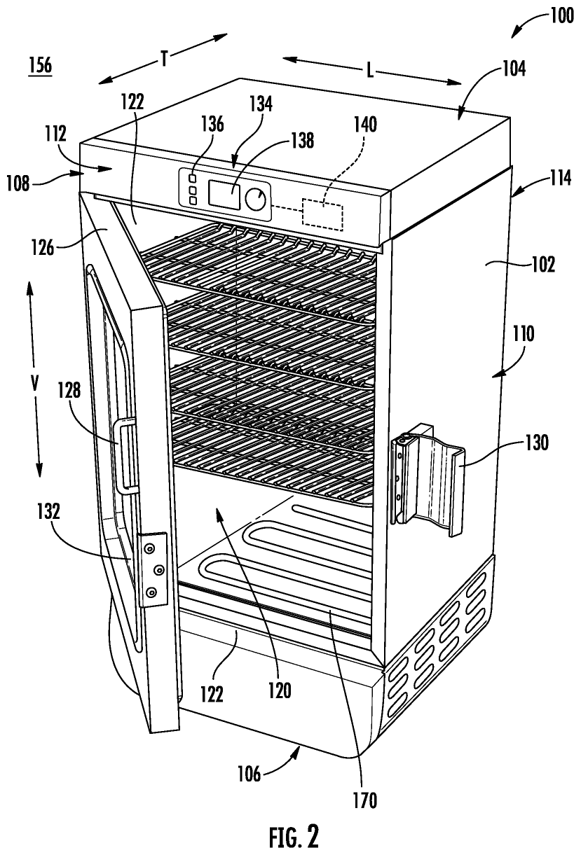

FIGS. 1 and 2 provide perspective views of an indoor smoker 100 according to an exemplary embodiment of the present subject matter with the door in the closed position and the open position, respectively. Indoor smoker 100 generally defines a vertical direction V, a lateral direction L, and a transverse direction T, each of which is mutually perpendicular, such that an orthogonal coordinate system is generally defined. As illustrated, indoor smoker 100 includes an insulated cabinet 102. Cabinet 102 of indoor smoker 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

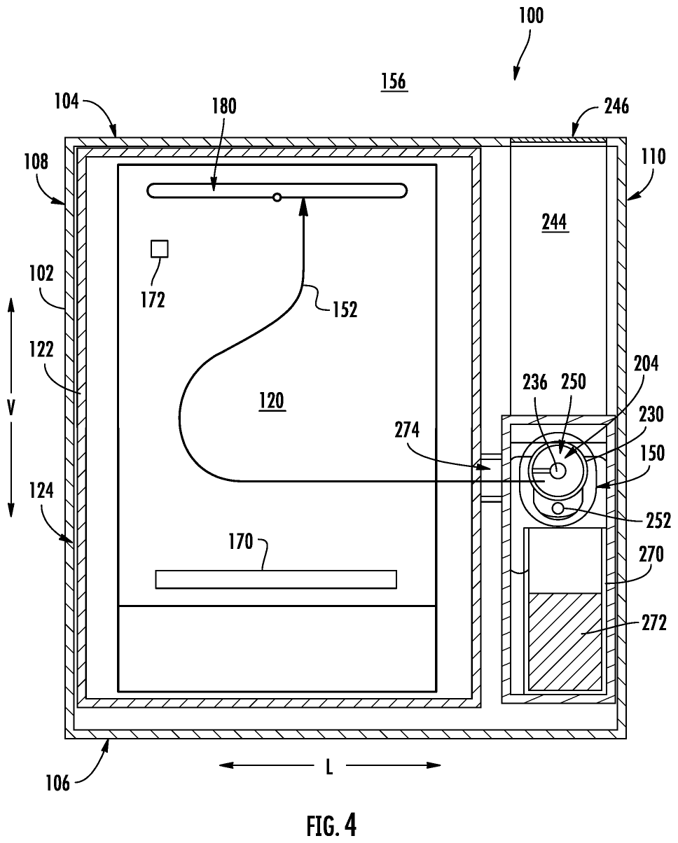

Within cabinet 102 is a smoking chamber 120 which is configured for the receipt of one or more food items to be cooked and/or smoked. In general, smoking chamber 120 is at least partially defined by a plurality of chamber walls 122. Specifically, smoking chamber 120 may be defined by a top wall, a rear wall, a bottom wall, and two sidewalls. These chamber walls 122 may define smoking chamber 120 and an opening through which a user may access food articles placed therein. In addition, chamber walls 122 may be joined, sealed, and insulated to help retain smoke and heat within smoking chamber 120. In this regard, for example, in order to insulate smoking chamber 120, indoor smoker 100 includes an insulation gap 124 (FIG. 4) defined between chamber walls 122 and cabinet 102. According to an exemplary embodiment, insulation gap 124 is filled with insulating material (not shown), such as insulating foam or fiberglass.

Indoor smoker 100 includes a door 126 rotatably attached to cabinet 102 in order to permit selective access to smoking chamber 120. A handle 128 is mounted to door 126 to assist a user with opening and closing door 126 and a latch 130 is mounted to cabinet 102 for locking door 126 in the closed position during a cooking or smoking operation. In addition, door 126 may include one or more transparent viewing windows 132 to provide for viewing the contents of smoking chamber 120 when door 126 is closed and also to assist with insulating smoking chamber 120.

Referring still to FIGS. 1 and 2, a user interface panel 134 and a user input device 136 may be positioned on an exterior of cabinet 102. User interface panel 134 may represent a general purpose Input/Output (“GPIO”) device or functional block. In some embodiments, user interface panel 134 may include or be in operative communication with user input device 136, such as one or more of a variety of digital, analog, electrical, mechanical or electro-mechanical input devices including rotary dials, control knobs, push buttons, and touch pads. User input device 136 is generally positioned proximate to user interface panel 134, and in some embodiments, user input device 136 may be positioned on user interface panel 134. User interface panel 134 may include a display component 138, such as a digital or analog display device designed to provide operational feedback to a user.

Generally, indoor smoker 100 may include a controller 140 in operative communication with user input device 136. User interface panel 134 of indoor smoker 100 may be in communication with controller 140 via, for example, one or more signal lines or shared communication busses, and signals generated in controller 140 operate indoor smoker 100 in response to user input via user input devices 136. Input/Output (“I/O”) signals may be routed between controller 140 and various operational components of indoor smoker 100 such that operation of indoor smoker 100 can be regulated by controller 140.

Controller 140 is a “processing device” or “controller” and may be embodied as described herein. Controller 140 may include a memory and one or more microprocessors, microcontrollers, application-specific integrated circuits (ASICS), CPUs or the like, such as general or special purpose microprocessors operable to execute programming instructions or micro-control code associated with operation of indoor smoker 100, and controller 140 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 140 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of an indoor smoker having a single smoking chamber, it should be appreciated that indoor smoker 100 is provided by way of example only. Other smoking appliances having different configurations, different appearances, and/or different features may also be utilized with the present subject matter, e.g., outdoor smokers, conventional oven appliances, or other suitable cooking appliances. Thus, the example embodiment shown in FIG. 1 is not intended to limit the present subject matter to any particular smoking configuration or arrangement. Moreover, aspects of the present subject matter may be used in any other consumer or commercial appliance where it is desirable to regulate a flow of smoke or harmful emissions in an appliance.

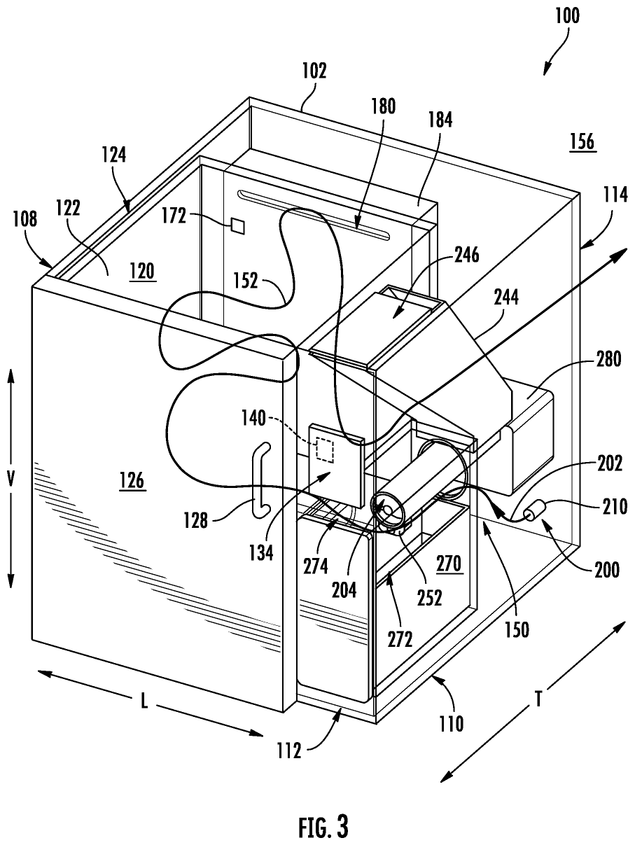

Referring now also to FIG. 3, various internal components of an indoor smoker 100 and their respective functions will be described according to an exemplary embodiment of the present subject matter. In this regard, FIG. 3 illustrates a partial perspective view of an indoor smoker 100 similar to that shown in FIG. 1. As shown, indoor smoker 100 generally includes smoking chamber 120 for receiving items to be cooked/smoked, a smoke generating device or smoke generating assembly 150 for generating a flow of smoke (indicated by reference numeral 152 in FIG. 3), and an exhaust system 154 for safely discharging that the air and/or smoke into an indoor environment 156 (i.e., outside of indoor smoker 100). Each of these systems and components will be described in detail below.

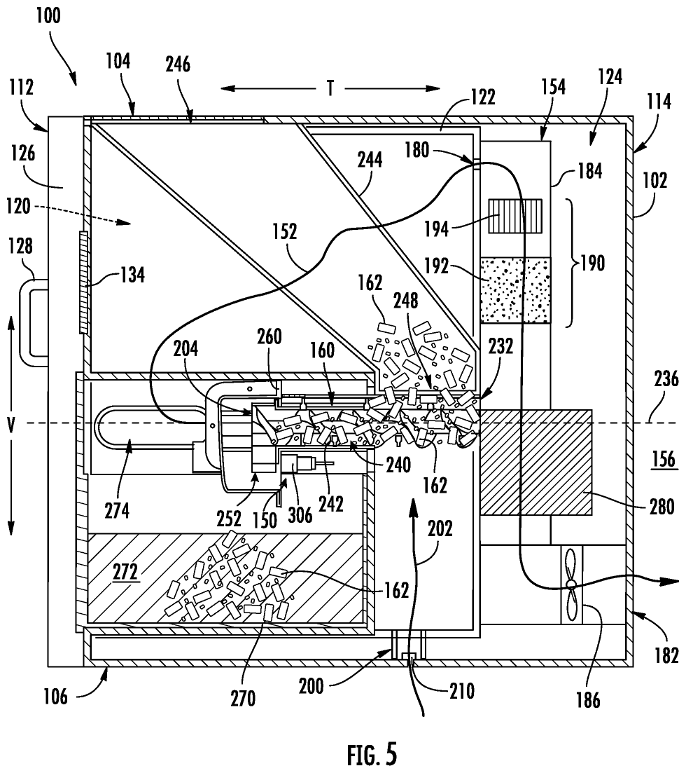

Referring to FIG. 5, smoke generating assembly 150 generally defines a smoldering chamber 160 which is configured for receiving combustible material 162. As used herein, “combustible material” is generally used to refer to any suitable material positioned within smoldering chamber 160 for generating smoke. Specifically, according to exemplary embodiments, combustible material 162 includes wood or wood byproducts, such as wood chunks, wood chips, wood pellets, or wood resin. According to the exemplary embodiment, smoke generating assembly 150 may include a door or another access panel (not shown) for providing selective access to smoldering chamber 160, e.g., to add additional combustible material 162. Smoke generating assembly 150 will be described in more detail below with respect to FIGS. 3 through 6.

As best shown in FIG. 4, in order to ensure a desirable cooking temperature within smoking chamber 120, indoor smoker 100 further includes a chamber heater 170 that is positioned within or otherwise in thermal communication with smoking chamber 120 for regulating the temperature in smoking chamber 120. In general, chamber heater 170 may include one or more heating elements positioned within cabinet 102 for selectively heating smoking chamber 120. For example, the heating elements may be electric resistance heating elements, gas burners, microwave heating elements, halogen heating elements, or suitable combinations thereof. Notably, because chamber heater 170 is operated independently of smoke generating assembly 150 (e.g., as described below), smoking chamber 120 may be maintained at any suitable temperature during a smoking process. More specifically, for example, chamber heater 170 may be turned off or on a very low setting for smoking cheeses or may be turned on high for quickly cooking and smoking meats.

In some embodiments, indoor smoker 100 also includes one or more sensors that may be used to facilitate improved operation of the appliance, such as described below. For example, indoor smoker 100 may include one or more temperature sensors which are generally operable to measure the internal temperature in indoor smoker 100, e.g., within smoking chamber 120 and/or smoldering chamber 160. More specifically, as illustrated, indoor smoker 100 includes a temperature sensor 172 positioned within smoking chamber 120 and being operably coupled to controller 140. In some embodiments, controller 140 is configured to vary operation of chamber heater 170 based on one or more temperatures detected by temperature sensor 172.

As described herein, “temperature sensor” may refer to any suitable type of temperature sensor. For example, the temperature sensors may be thermocouples, thermistors, or resistance temperature detectors. In addition, temperature sensor 172 may be mounted at any suitable location and in any suitable manner for obtaining a desired temperature measurement, either directly or indirectly. Although exemplary positioning of certain sensors is described below, it should be appreciated that indoor smoker 100 may include any other suitable number, type, and position of temperature sensors according to alternative embodiments.

As mentioned briefly above, indoor smoker 100 further includes an exhaust system 154 which is generally configured for safely discharging the flow of smoke 152 from indoor smoker 100. Specifically, according to the illustrated embodiment, exhaust system 154 generally extends between a chamber outlet 180 and a discharge vent 182 defined by cabinet 102 for directing the flow of smoke 152 from smoking chamber 120 to the environment 156. Although an exemplary exhaust system 154 is described below, it should be appreciated that variations and modifications may be made while remaining within the scope of the present subject matter. For example, the routing of ducts, the catalytic converter arrangement, and the types of sensors used may vary according to alternative embodiments.

As shown, exhaust system 154 includes an exhaust duct 184 that generally extends between and provides fluid communication between chamber outlet 180 and discharge vent 182. Indoor smoker 100 further includes an air handler 186 that is operably coupled with exhaust duct 184 facilitating the smoldering process and smoke generating process. For example, air handler 186 urges the flow of smoke 152 through exhaust duct 184 and out of discharge vent 182 to environment 156. According to the illustrated exemplary embodiment, air handler 186 is an axial fan positioned within exhaust duct 184. However, it should be appreciated that according to alternative embodiments, air handler 186 may be positioned at any other suitable location and may be any other suitable fan type, such as a tangential fan, a centrifugal fan, etc.

In addition, according to an exemplary embodiment, air handler 186 is a variable speed fan such that it may rotate at different rotational speeds, thereby generating different air flow rates. In this manner, the amount of smoke drawn from smoldering chamber 160 may be continuously and precisely regulated. Moreover, by pulsing the operation of air handler 186 or throttling air handler 186 between different rotational speeds, the flow of smoke 152 drawn into smoking chamber 120 may enter from a different direction, may have a different flow velocity, or may generate a different flow pattern within smoking chamber 120. Thus, by pulsating the variable speed fan or otherwise varying its speed, the flow of smoke 152 may be randomized, thereby eliminating stagnant regions within smoking chamber 120 and better circulating the flow of smoke 152 to provide a more even cooking/smoking profile.

As illustrated, indoor smoker 100 further includes a catalytic converter 190 which is positioned within exhaust duct 184 for lowering or removing volatile organic compounds (VOCs) from the flow of smoke 152. As used herein, “catalytic converter” or variations thereof may be used to refer to any component, machine, or device that is configured for removing or lowering volatile organic compounds (VOCs), toxic gases, harmful emissions, pollutants, or undesirable compounds from a flow of air and smoke. For example, according to the illustrated embodiment, catalytic converter 190 generally includes a catalytic element 192 and a catalyst heater 194.

In general, catalytic element 192 includes a material that causes an oxidation and a reduction reaction. For example, precious metals such as platinum, palladium, and rhodium are commonly used as catalyst materials, though other catalysts are possible and within the scope of the present subject matter. In operation, the catalytic element 192 may combine oxygen (O₂) with carbon monoxide (CO) and unburned hydrocarbons to produce carbon dioxide (CO₂) and water (H₂O). In addition, according to exemplary embodiments, catalytic element 192 may remove nitric oxide (NO) and nitrogen dioxide (NO₂).

Notably, catalytic converters typically require that the catalyst be heated to a suitably high temperature in order to catalyze the necessary chemical reactions. Therefore, catalyst heater 194 is in thermal communication with catalytic element 192 for heating it to a suitable temperature, such as approximately 800° F. According to the illustrated embodiment, catalyst heater 194 is positioned upstream of catalytic element 192 to provide thermal energy through convection. However, it should be appreciated that according to alternative embodiments, catalyst heater 194 may be in direct contact with catalytic element 192 to provide thermal energy through conduction, or may be thermally coupled to catalytic element 192 in any other suitable manner. In order to ensure a catalyst temperature of catalytic element 192 remains above a temperature suitable for controlling emissions, indoor smoker 100 may further include a catalyst temperature sensor (not shown) that may be monitored by controller 140.

Referring now specifically to FIGS. 3 through 6, the construction and operation of smoke generating assembly 150 will be described in more detail according to an exemplary embodiment of the present subject matter. As best shown in FIG. 5, indoor smoker 100 defines an air inlet 200 for receiving air to support the combustion or smoldering process. Specifically, air inlet 200 is configured for receiving a flow of combustion air (indicated by reference numeral 202 in FIG. 5) from the ambient environment 156 surrounding indoor smoker 100 or from another air supply source. During a smoking process, combustible material 162 is ignited and the flow of combustion air 202 supports the smoldering process to generate the flow of smoke 152. Smoke generating assembly 150 further defines a smoke outlet 204 for providing a flow of smoke 152 into smoking chamber 120 during a smoking operation, as will be described in detail below.

In addition, indoor smoker 100 may further include features for preventing or regulating the flow of combustion air 202 from entering indoor smoker 100 from environment 156 when the flow of such air is not desired. In this regard, for example, indoor smoker 100 may include an inlet check valve 210 which is operably coupled to air inlet 200. In general, this check valve prevents the flow of combustion air 202 from entering smoldering chamber 160 when not desired. For example, inlet check valve 210 may have a “cracking pressure,” which is used herein to refer to the pressure, or more precisely the negative pressure, required within smoldering chamber 160 to open inlet check valve 210. In this manner, inlet check valve 210 may be designed to permit the flow of combustion air 202 only when air handler 186 is operating and urging air through smoldering chamber 160, thus facilitating the quick and effective asphyxiation of combustible material 162 within smoldering chamber 160 when desired. According to still other example embodiments, inlet check valve 210 may be omitted altogether.

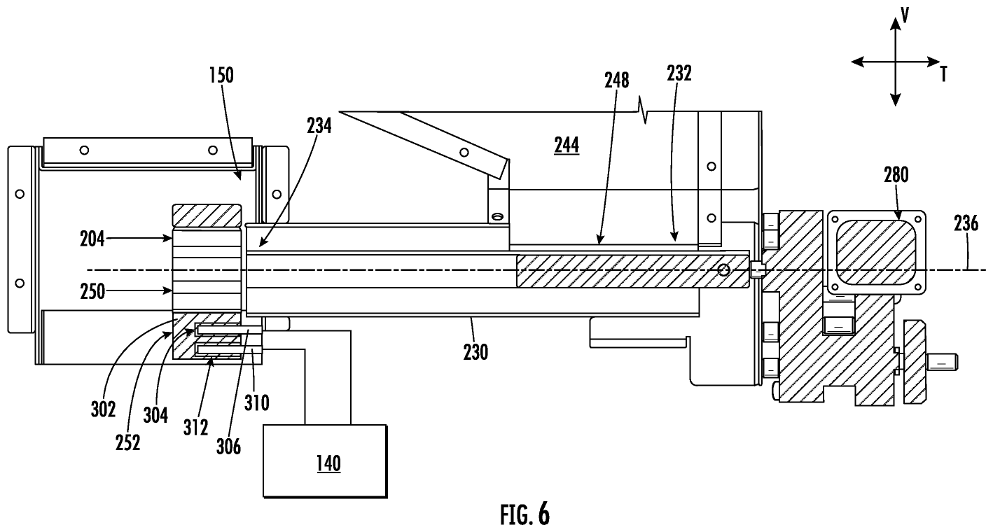

Referring now specifically to FIGS. 5 and 6, according to the illustrated embodiment, smoke generating assembly 150 generally includes a smoke barrel 230 that defines smoldering chamber 160. Specifically, smoke barrel 230 extends between a first end 232 and a second end 234 substantially along a central axis 236. Specifically, as illustrated, central axis 236 extends substantially within a horizontal plane within cabinet 102, e.g., directly along the transverse direction T. In general, smoke barrel 230 is configured for receiving the combustible material 162 and facilitating a smoldering process. As shown, smoke barrel 230 has a substantially cylindrical shape and is formed from a substantially rigid and temperature resistant material, such as steel. However, it should be appreciated that smoke barrel 230 may be formed from different materials, may have different geometries, and may be configured differently within cabinet 102 according to alternative embodiments of the present subject matter.

Smoke generating assembly 150 further includes a rotating auger 240 that is rotatably mounted within smoldering chamber 160 and generally rotates about central axis 236, e.g., such that rotating auger 240 is coaxial with smoke barrel 230. As shown, an outer diameter of rotating auger 240 is substantially equivalent to an inner diameter of smoke barrel 230, such that a helical blade 242 of rotating auger 240 may advance combustible material 162 within smoldering chamber 160 as rotating auger 240 is rotated about central axis 236. More specifically, the combustible material 162 is generally urged from first end 232 toward second end 234 of smoke barrel 230.

As illustrated, smoke generating assembly 150 may further include a hopper 244 that is generally configured for storing and selectively depositing combustible material 162 into smoldering chamber 160. More specifically, as illustrated, hopper 244 may be a large, tapered reservoir with a top opening 246 positioned at top 104 of cabinet 102. A user may fill hopper 244 by pouring or providing combustible material 162 into hopper 244 through top opening 246. Hopper 244 may taper toward a supply opening 248 positioned at a bottom of hopper 244. As shown, supply opening 248 opens into smoldering chamber 160 at a top of smoke barrel 230. More specifically, supply opening 248 is joined to smoke barrel 230 proximate first end 232 of smoke barrel 230. In this manner, fresh combustible material 162 is typically provided into smoldering chamber 160 proximate first end 232 of smoke barrel 230 and is urged by rotating auger 240 toward second end 234 of smoke barrel 230. As illustrated, smoke generating assembly 150 may generally define a discharge port 250 proximate second end 234 of smoke barrel 230 for discharging consumed combustible material 162.

As best shown in FIGS. 5 and 6, smoke generating assembly 150 includes one or more smoldering heaters 252 which are positioned adjacent smoldering chamber 160 or otherwise placed in thermal communication with combustible material 162 stored in smoldering chamber 160 for smoldering combustible material 162. According to an exemplary embodiment, smoldering heater 252 may include one or more cartridge heaters or silicon nitride igniters. Alternatively, smoldering heater 252 may include any other suitable type, position, and configuration of heating elements. As used herein, the term “heating element,” “heaters,” and the like may generally refer to electric resistance heating elements, gas burners, microwave heating elements, halogen heating elements, or suitable combinations thereof.

As used herein, the verb “smolder” or variations thereof is intended to refer to burning a combustible material (e.g., combustible material 162) slowly such that smoke is generated but little or no flame is generated. In this manner, the combustible material is not expended quickly, but a large amount of smoke is generated for the smoking process. Notably, the burn rate of combustible material and the amount of smoke generated is regulated using smoldering heater 252 positioned within smoldering chamber 160. For typical combustible material used in smokers, e.g., wood and wood byproducts, a typical smoldering temperature is between about 550° F. and 800° F. However, the exact temperature may vary depending on the combustible material used, the air flow rate through smoldering chamber 160, the level of combustible material 162, and other factors.

According to the exemplary illustrated embodiment, smoldering heater 252 is positioned proximate second end 234 of smoke barrel 230, e.g., downstream of second end 234 of smoke barrel 230. For example, smoldering heater 252 may at least partially define smoke outlet 204 of smoke generating assembly 150. Specifically, as illustrated, smoke outlet 204 corresponds to discharge port 250 of smoke generating assembly 150, which may simply be an open end of smoldering heater 252. In this manner, as rotating auger 240 rotates, combustible material 162 positioned within smoldering chamber 160 is slowly but progressively advanced past smoldering heater 252. After combustible material 162 positioned near smoldering heater 252 is consumed or smoldered, rotating auger 240 may rotate to advance the consumed material toward discharge port 250 where it may be pushed out of smoldering chamber 160. It should be appreciated that advancing the combustible material 162 past the smoldering heater 252 may include any suitable number and duration of dwell times, e.g., to permit the combustible material to generate smoke and be consumed.

According to exemplary embodiments, smoldering heater 252 may be positioned on a distal end of rotating auger 240, e.g., aligned along central axis 236 proximate second end 234. As such, rotating auger 240 may pass through smoke barrel 230 and through a central aperture smoldering heater 252 to extend out of discharge port 250. In this manner, rotating auger 240 may serve to advance combustible material 162 from first end 232 of smoke barrel 230, past second end 234 of smoke barrel 230, through and across smoldering heater 252, then out of discharge port 250.

According to an exemplary embodiment, a container 270 may be configured for receiving consumed combustible material 162 when discharged from smoke generating assembly 150. In this regard, for example, container 270 may be positioned directly below smoke barrel 230, smoldering heater 252, and/or discharge port 250 such that used combustible material 162 may fall therein and immediately extinguish. For example, according to the illustrated embodiment, container 270 is filled with water 272 to immediately extinguish combustible material 162 when dropped into container 270. However, it should be appreciated that other liquids or materials for extinguishing combustible material 162 may be contained within container 270. In addition, as illustrated, container 270 may be positioned below or directly define a chamber inlet 274 that is positioned adjacent smoke outlet 204. In this manner, the flow of smoke 152 exiting smoke barrel 230 may pass directly into smoking chamber 120 through chamber inlet 274 while consumed combustible material 162 may fall directly into water 272 within container 270. According to alternative embodiments, consumed combustible material 162 may be discharged in any other suitable manner into any other suitable container or reservoir.

Referring again to FIGS. 5 and 6, smoke generating assembly 150 may further include a drive mechanism 280 that is mechanically coupled to rotating auger 240. Controller 140 (or another dedicated controller) may be in operative communication with drive mechanism 280 and may be configured for intermittently rotating the rotating auger 240 to advance combustible material 162 along central axis 236. Specifically, drive mechanism 280 may include a drive motor (not shown) and a transmission assembly (not shown) or another suitable geared arrangement for transferring torque from the drive motor to rotating auger 240. As used herein, “motor” may refer to any suitable drive motor and/or transmission assembly for driving rotating auger 240. For example, the drive motor may be a brushless DC electric motor, a stepper motor, or any other suitable type or configuration of motor. For example, the drive motor may be an AC motor, an induction motor, a permanent magnet synchronous motor, or any other suitable type of AC motor. In addition, the drive motor and the transmission assembly may include any suitable motor or transmission sub-assemblies, clutch mechanisms, or other components.

In order to facilitate proper smoldering of combustible material 162, it may be desirable to drive rotating auger 240 intermittently, e.g., in a non-continuous manner. Specifically, according to an exemplary embodiment, rotating auger 240 may be rotated for a particular time duration once during every predetermined rotation period. For example, the time duration of rotation may be the amount of time drive mechanism 280 should drive rotating auger 240 to discharge all combustible material 162 that is smoldering from smoke barrel 230. In addition, the predetermined rotation period may be the amount of time necessary for a fresh portion of the smoldering material 162 to be consumed. Notably, drive mechanism 280 may discharge combustible material 162 from smoke barrel 230 before combustible material 162 is fully consumed, e.g., to prevent forming ash which may introduce acrid smoke flavors. According to an exemplary embodiment, the time duration of rotation is approximately 12 seconds while the predetermined rotation period is three minutes. Other rotation schedules are possible and within the scope of the present subject matter. Indeed, such rotation schedules may vary based on a variety of factors, such as the combustible material used, the temperature of the smoldering heater, the rate of air flow through smoke barrel 230, etc.

Thus, during operation of indoor smoker 100, air handler 186 draws the flow of combustion air 202 into smoldering chamber 160 through air inlet 200. The flow of combustion air 202 and combustible material 162 in the smoldering chamber 160 generate the flow of smoke 152 which is drawn into smoking chamber 120 as described herein. The flow of smoke 152 passes through smoking chamber 120 for performing a smoking process on food items positioned therein before exiting smoking chamber 120 through chamber outlet 180. Air handler 186 then continues to urge the flow of smoke 152 through catalytic converter 190 and exhaust duct 184 before passing out discharge vent 182.

Referring now specifically to FIG. 6, smoldering heater 252 may generally include a heating block 302 that defines a heater sleeve 304. In addition, a heating element 306 may be positioned within heater sleeve 304 for selectively heating the heating block 302 when smoldering heater 252 is energized. As explained above, heating element 306 may generally include one or more cartridge heaters, silicon nitride igniters, or any other suitable number, type, and configuration of heating elements. In addition, it should be appreciated that heating block 302 may generally be constructed from any suitably conductive material. For example, heating block 302 may be constructed from aluminum or any other metal having high thermal conductivity. It should be appreciated that other types, positions, and configurations of heating elements may be used while remaining within the scope of the present subject matter.

According to example embodiments, smoke generating assembly 150 may further include one or more temperature sensors 310 that are in thermal communication with smoldering heater 252 for measuring a smoldering temperature. In this regard, temperature sensor 310 may be mounted within a sensor sleeve 312 defined in heating block 302 for monitoring a temperature of heating block 302. Although temperature sensor 310 is illustrated and described as being directly embedded within and contacting heating block 302, it should be appreciated that any other suitable type, position, and configuration of temperature sensing device(s) may be used according to alternative embodiments. Indeed, smoke generating assembly 150 may alternatively use a non-contact temperature sensor or any other sensor in thermal communication or thermally coupled to heating block 302.

As used herein, “temperature sensor” or the equivalent is intended to refer to any suitable type of temperature measuring system or device positioned at any suitable location for measuring the desired temperature. Thus, for example, temperature sensor 310 may each be any suitable type of temperature sensor, such as a thermistor, a thermocouple, a resistance temperature detector, a semiconductor-based integrated circuit temperature sensor, etc. In addition, temperature sensor 310 may be positioned at any suitable location and may output a signal, such as a voltage, to a controller that is proportional to and/or indicative of the temperature being measured. Although exemplary positioning of temperature sensors is described herein, it should be appreciated that indoor smoker 100 may include any other suitable number, type, and position of temperature sensors and/or other sensors according to alternative embodiments.

Referring again to FIG. 1, a schematic diagram of an external communication system 320 will be described according to an exemplary embodiment of the present subject matter. In general, external communication system 320 is configured for permitting interaction, data transfer, and other communications between indoor smoker 100 and one or more external devices. For example, this communication may be used to provide and receive operating parameters, user instructions or notifications, performance characteristics, user preferences, or any other suitable information for improved performance of indoor smoker 100. In addition, it should be appreciated that external communication system 320 may be used to transfer data or other information to improve performance of one or more external devices or appliances and/or improve user interaction with such devices.

For example, external communication system 320 permits controller 140 of indoor smoker 100 to communicate with a separate device external to indoor smoker 100, referred to generally herein as an external device 322. As described in more detail below, these communications may be facilitated using a wired or wireless connection, such as via a network 324. In general, external device 322 may be any suitable device separate from indoor smoker 100 that is configured to provide and/or receive communications, information, data, or commands from a user. In this regard, external device 322 may be, for example, a personal phone, a smartphone, a tablet, a laptop or personal computer, a wearable device, a smart home system, or another mobile or remote device.

In addition, a remote server 326 may be in communication with indoor smoker 100 and/or external device 322 through network 324. In this regard, for example, remote server 326 may be a cloud-based server 326, and is thus located at a distant location, such as in a separate state, country, etc. According to an exemplary embodiment, external device 322 may communicate with a remote server 326 over network 324, such as the Internet, to transmit/receive data or information, provide user inputs, receive user notifications or instructions, interact with or control indoor smoker 100, etc. In addition, external device 322 and remote server 326 may communicate with indoor smoker 100 to communicate similar information.

In general, communication between indoor smoker 100, external device 322, remote server 326, and/or other user devices or appliances may be carried using any type of wired or wireless connection and using any suitable type of communication network, non-limiting examples of which are provided below. For example, external device 322 may be in direct or indirect communication with indoor smoker 100 through any suitable wired or wireless communication connections or interfaces, such as network 324. For example, network 324 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 320 is described herein according to an exemplary embodiment of the present subject matter. However, it should be appreciated that the exemplary functions and configurations of external communication system 320 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction of indoor smoker 100 and smoke generating assembly 150 have been described according to example embodiments of the present subject matter, an exemplary method 400 of operating a smoke generating assembly 150 will be described. Although the discussion below refers to the exemplary method 400 of operating smoke generating assembly 150 of indoor smoker 100, one skilled in the art will appreciate that the exemplary method 400 is applicable to the operation of a variety of other smoking appliances and smoke generators.

In exemplary embodiments, the various method steps as disclosed herein may be performed by controller 140 or a separate, dedicated controller. In this regard, as described herein, controller 140 of indoor smoker 100 may implement all steps of method 400. However, it should be appreciated that according to alternative embodiments, controller 140 may offload the performance of steps described herein, e.g., by communicating with network 324 or remote server 326. Other distributed computing arrangements are possible and within the scope of the present subject matter.

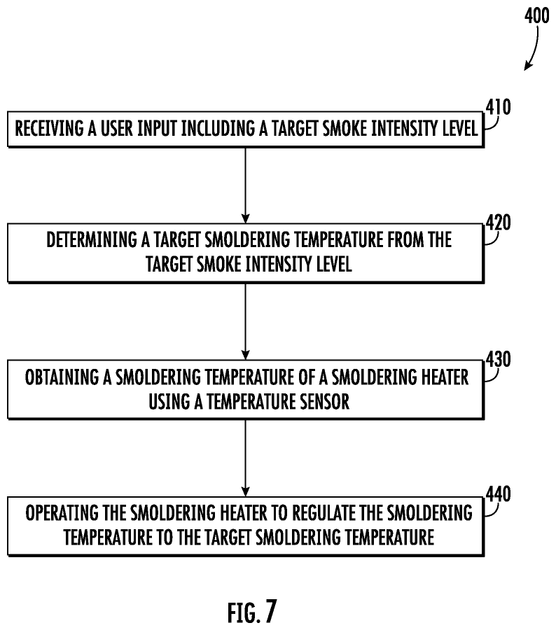

Referring now to FIG. 7, method 400 includes, at step 410, receiving a user input including a target smoke intensity level. In general, the target smoke intensity level may refer to the desired amount or rate of smoke generation. In this regard, aspects of the present subject matter are generally directed toward improving smoke generation in a smoker using a variable temperature igniter or smoldering heater 252. Moreover, aspects of the present subject matter are directed to closed-loop control of such a variable temperature smoldering heater 252 based on the target smoke intensity level or the quality of the generated smoke. According to example embodiments, the user input regarding the target smoke intensity level may be received in any suitable manner, such as through user interface panel 134 or an external device 322 through a network 324 (e.g., such as a user's cell phone).

Step 420 generally includes determining a target smoldering temperature from the target smoke intensity level. For example, the target smoke intensity level may be set by a user using a user input device 136, such as a dial that is rotated between smoke levels L1 through L5 (or any other suitable range). For example, each smoke level may be mapped to a specific ignitor temperature set point. According to an example embodiment, L1 through L5 may correspond to a target smoldering temperature between about 200° F. and 1200° F., between about 300° F. and 1000° F., between about 450° F. and 850° F., between about 550° F. and 800° F., or any other suitable temperature range. In addition, it should be appreciated that the user input may directly specify the target smoldering temperature, e.g., in degrees Fahrenheit. Other suitable matters of inputting the target smoke intensity level and the smoldering temperature are possible and within the scope of the present subject matter.

Step 430 may include obtaining a smoldering temperature of a smoldering heater using a temperature sensor. In this regard, continuing the example from above, the smoldering temperature of heating block 302 may be obtained using temperature sensor 310. It should be appreciated that method 400 may include periodically or continuously monitoring the temperature of heating block 302 and smoldering heater 252 to provide feedback regarding the operation of smoke generating assembly 150.

Step 440 generally include operating the smoldering heater to regulate the smoldering temperature to the target smoldering temperature. In this regard, by continuously monitoring the smoldering temperature of heating block 302, controller 140 of indoor smoker 100 may be used to implement closed-loop control of the block temperature, thereby improving smoke generation and precisely tracking the target smoke intensity level throughout the smoking process.

Accordingly, step 440 generally includes operating smoldering heater 252 to drive the smoldering temperature to the target smoldering temperature. In this regard, step 440 may include implementing a closed-loop feedback control algorithm based on the measured smoldering temperature temperatures relative to the target smoldering temperature. According to example embodiments, the closed-loop feedback control algorithm may include the use of proportional (P), proportional-integral (PI), proportional-integral-derivative (PID), or bang-bang control for feedback-based control implemented with, e.g., temperature feedback from one or more temperature sensors 310. It should be appreciated that other suitable methods of performing closed-loop control are possible and within the scope of the present subject matter.

Notably, method 400 may further include adjusting other operating parameters of indoor smoker 100 to further improve the smoke generation, both in terms of quality and flow rate. For example, according to an example embodiment, method 400 may further include adjusting a feed rate of rotating auger 240 while operating smoldering heater 252 to regulate the smoldering temperature to the target smoldering temperature as described above. Thus, by providing independent control of the feed rate of combustible material 162 and the temperature of smoldering heater 252, precise quality smoke generation may be achieved. Moreover, this smoke regulation may be obtained despite variations in the type of combustible material 162, variations in the temperature of the smoking chamber 120 (e.g., which may affect the temperature of smoke generating assembly 150), or other variations which may affect the smoke generating process. It should be appreciated that other operating parameter adjustments are possible and within the scope of the present subject matter.

FIG. 7 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 400 are explained using indoor smoker 100 and smoke generating assembly 150 as an example, it should be appreciated that this method may be applied to the operation of any smoke generation device.

As explained herein, aspects of the present subject matter are generally directed to an ignitor control method in a pellet smoker. The system may control the smoke generation by taking input from the user interface or a remote signal (Wi-Fi, Bluetooth, remote server, etc.) and use those signals to adjust the setpoint value of a smoke generator ignitor. For example, the smoke level can be adjusted from level 1 to 5 by the user, which are mapped on various ignitor setpoints (e.g., L1 is 550° F. and L5 is 800° F., etc.).

In addition, according to an example embodiment, a closed-loop temperature control algorithm (such as P, PI, PID, bang-bang, or other common control scheme) may be used to control the system and give proper feedback such that the output of the ignitor heater is modulated to achieve a goal temperature at the temperature sensor, regardless of thermal output from each pellet, the temperature of the cooking chamber, etc. As a result, the ability to alter the temperature of the igniter in a closed-loop manner allows various levels of smoke generation while maintaining optimum smoke quality.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A smoke generating assembly comprising:
a smoke barrel defining a smoldering chamber that extends between a first end and a second end along a central axis, the smoke barrel being configured for receiving combustible material;
an auger positioned within the smoke barrel and being rotatable about the central axis for selectively urging the combustible material from the first end toward the second end of the smoldering chamber;
a smoldering heater positioned adjacent the smoke barrel for smoldering the combustible material as the auger advances the combustible material past the smoldering heater;
a temperature sensor in thermal communication with the smoldering heater for measuring a smoldering temperature; and
a controller in operative communication with the smoldering heater and the temperature sensor, the controller being configured to operate the smoldering heater to regulate the smoldering temperature to a target smoldering temperature.

2. The smoke generating assembly of claim 1, wherein the controller is further configured to:
receive a user input including a target smoke intensity level; and
determine the target smoldering temperature from the target smoke intensity level.

3. The smoke generating assembly of claim 2, wherein the smoke generating assembly is in operative communication with a user interface, and wherein user input is received through the user interface.

4. The smoke generating assembly of claim 3, wherein the smoke generating assembly is in operative communication with a remote device through an external network, and wherein the user input is received through the remote device.

5. The smoke generating assembly of claim 1, wherein the target smoldering temperature is between about 300° F. and 1000° F.

6. The smoke generating assembly of claim 5, wherein the target smoldering temperature is between about 550° F. and 800° F.

7. The smoke generating assembly of claim 1, wherein operating the smoldering heater to regulate the smoldering temperature to the target smoldering temperature comprises:
implementing a closed-loop feedback control algorithm based on the smoldering temperature and the target smoldering temperature.

8. The smoke generating assembly of claim 7, wherein the closed-loop feedback control algorithm comprises a proportional control algorithm, a proportional-integral control algorithm, a proportional-integral-derivative control algorithm, or a bang-bang control algorithm.

9. The smoke generating assembly of claim 1, wherein the controller is further configured to:
adjust a feed rate of the auger while operating the smoldering heater to regulate the smoldering temperature to the target smoldering temperature.

10. The smoke generating assembly of claim 1, wherein the smoldering heater comprises:
a heating block defining a heater sleeve; and
a heating element positioned within the heater sleeve for selectively heating the heating block.

11. The smoke generating assembly of claim 10, wherein the temperature sensor is embedded in the heating block.

12. A method of operating a smoke generating assembly, the smoke generating assembly comprising a smoldering heater positioned adjacent a smoke barrel for smoldering combustible material as an auger advances the combustible material past the smoldering heater and a temperature sensor in thermal communication with the smoldering heater, the method comprising:
receiving a user input including a target smoke intensity level;
determining a target smoldering temperature from the target smoke intensity level;
obtaining a smoldering temperature of the smoldering heater using the temperature sensor; and
operating the smoldering heater to regulate the smoldering temperature to the target smoldering temperature.

13. The method of claim 12, wherein the smoke generating assembly is in operative communication with a user interface, and wherein user input is received through the user interface.

14. The method of claim 12, wherein the smoke generating assembly is in operative communication with a remote device through an external network, and wherein the user input is received through the remote device.

15. The method of claim 12, wherein the target smoldering temperature is between about 300° F. and 1000° F.

16. The method of claim 15, wherein the target smoldering temperature is between about 550° F. and 800° F.

17. The method of claim 12, wherein operating the smoldering heater to regulate the smoldering temperature to the target smoldering temperature comprises:
implementing a closed-loop feedback control algorithm based on the smoldering temperature and the target smoldering temperature.

18. The method of claim 17, wherein the closed-loop feedback control algorithm comprises a proportional control algorithm, a proportional-integral control algorithm, a proportional-integral-derivative control algorithm, or a bang-bang control algorithm.

19. The method of claim 12, further comprising:
adjusting a feed rate of the auger while operating the smoldering heater to regulate the smoldering temperature to the target smoldering temperature.

20. An indoor smoker comprising:
a cabinet;
a smoking chamber positioned within the cabinet; and
a smoke generating assembly for providing a flow of smoke into the smoking chamber, the smoke generating assembly comprising:
a smoke barrel defining a smoldering chamber that extends between a first end and a second end along a central axis, the smoke barrel being configured for receiving combustible material;
an auger positioned within the smoke barrel and being rotatable about the central axis for selectively urging the combustible material from the first end toward the second end of the smoldering chamber;
a smoldering heater positioned adjacent the smoke barrel for smoldering the combustible material as the auger advances the combustible material past the smoldering heater; and
a temperature sensor in thermal communication with the smoldering heater for measuring a smoldering temperature; and
a controller in operative communication with the smoldering heater and the temperature sensor, the controller being configured to operate the smoldering heater to regulate the smoldering temperature to a target smoldering temperature.
